(19) United States
(12) Patent Application Publication
(10) Pub. No.: US 2002/0134371 A1
(43) Pub. Date: Sep. 26, 2002

(54) Oven mounted hood assembly for evacuating heat and airborne particulates

(76) Inventors: John M. Ward, Clinton Twp, MI (US); Gregory Kolecki, Ann Arbor, MI (US)

Correspondence Address: Douglas J. McEvoy, Gifford, Krass, Groh, Sprinkle, Anderson & Citkowski, P.C., 280 N. Old Woodward Ave., Suite 400, Birmingham, MI, 48009, US

(21) Appl. No.: 09/814,532

(22) Filed: Mar. 22, 2001

(51) Int. Cl. A21B 1/00; F24C 15/20

(52) U.S. Cl. 126/299 R; 126/21 R; 99/443 C

(57) ABSTRACT

An mounted hood assembly for use with a conveyorized type oven located within an interior enclosure. The oven includes one or more conveyor belts extending between inlet and outlet sides, the oven further including an open space defined within side walls associated with the inlet and outlet sides and which is contiguous with the upper side of the conveyor, the open space further extending from the inlet to the outlet sides of the oven. One or more hood assemblies are constructed of elongated and three-dimensional shaped bodies and which are each mountable to an oven side wall associated with at least one of the inlet and outlet sides. A generally downwardly and elongate extending inlet is arranged along each of the elongated bodies and arrays in an overhanging fashion above the associated inlet and/or outlet side location of the conveyor belt. The bodies each further include a baffle filter mounted in likewise elongate extending fashion within the body and proximate the inlet. An outlet is defined at a further location of each elongate body and is internally communicable with the inlet. A length of ductwork connects to each elongated body, through its associated outlet, and extends in a substantially upward fashion from the interior enclosure to an externally mounted blower assembly.

### BACKGROUND OF THE INVENTION

1. Field of the Invention

The present invention relates generally to hood assemblies for evacuating heat, grease and other types of airborne exhaust particulates result from cooking appliances such as ovens. More specifically, the present invention discloses an improved and oven mounted hood assembly, located much more proximately to the heated exhaust zone of the cooking appliance, and for evacuating such exhaust components in a much more efficient manner.

2. Description of the Prior Art

Heat and grease extraction units, such as overhead mounted hood assemblies, are known in the art for assisting in the removal of the byproducts of commercial and industrial cooking operations. Two examples of such overhead mounted ventilation systems are illustrated in U.S. Pat. Nos. 6,041,772 and 6,041,774, both issued to Ward et al., and which operate to remove heated exhaust air and airborne particulates (most typically grease) which result from the operation most notably of a conveyorized cooking oven. In each case, a baffle arrangement is provided along a supply side of the oven to regulate an inflow of clean outside air and, combined with filters arranged along an exhaust side of the oven and blowers for respectively driving air flow through both the inlet and exhaust sides, operate to remove the excess heat and grease in an upward ascending manner from the oven.

Another example of a conveyorized oven exhaust system is set forth in U.S. Pat. No. 5,421,320, issued to Brown, and teaches a hood assembled from a plurality of modules including a central makeup air module, an exhaust plenum module and end modules positioned over the conveyor inlets and outlets and which make up air directors. The overhanging end modules also include partitions therein which cooperate with the walls of the overhang portions to provide ducts at the front of the overhang portions to capture fumes from the area above the front of the conveyor ends. Air flow guides around the extending portions of the conveyors assist in the discharge of air from the front of the makeup air plenum down the front of the ovens to cool the front exterior surfaces.

U.S. Pat. No. 4,616,562, issued to Kuechler, discloses a ventilation system for pizza ovens and which includes a heat shield directed around all four sides and over the top of the oven by a heat shroud that covers the top, back and ends, but leaves the front of the oven free for access to the doors that extend across most of the oven front. The shroud side panels are provided with deflectors that redirect air to flow forwardly along the oven sides and to cause it to follow in a path flowing laterally inwardly and upwardly along the front, providing a curtain of cooling air that mixes with and entrains the heated air at the oven front face to be drawn into an exhaust port at the center of the top of the oven front. The shroud additionally provides the both cooling air passages and passages for intake of combustion air into the oven burners and also provides passages between the oven and the shroud for flow of exhaust gases to be combined with the exhausted ventilation air which entrains the heated air from the exterior surface of the oven.

Finally, U.S. Pat. No. 4,738,243, issued to Welsh, teaches a kitchen exhaust hood covering a top of an oven and food conveyors which extend on both sides of the oven. Plates in the hood cooperate with the walls of the hood to provides slots at the hood front and sides to accelerate the air under the plates adjacent the slots and to provide a high velocity exhaust air flow upward in the hood at the front and sides of the hood to capture heat and fumes. The plates are further located slightly above the lower edge of the hood to minimize induction of room air horizontally into the hood under the edge, and assure collection of air that has only been associated with the oven and has accumulated heat or collected contaminants. Air flow guides located at ends of the conveyor direct heat and fumes around the ends of the conveyor and toward the conveyor covering hood portions.

While providing a unique exhaust hood assembly, Welsh suffers from the shortcoming of very rigid requirements in the arrangement of the overhead ductwork. Additionally the Welsh design does not provide any significant degree of visibility from the front to the back of the oven (and across the top of the oven), this being a desirous factor in chain franchise operations, such as pizzerias, where the manager/owner desires a better field of view of the employees in the rear area of the store.

### SUMMARY OF THE PRESENT INVENTION

The present invention is a hood assembly capable of being mounted directly to a conveyorized oven and which provides for much more efficient evacuation of heat, grease and other airborne particulates emanating from both the inlet and, in particular, the outlet sides of the conveyor oven. The design of the direct oven mounted hood unit of the present invention provides the feature of more localized heat and particulate evacuation, thus doing away with the necessity of installing a make up air unit with the interior enclosure, and combined with much greater visibility from the front to back of the oven resulting from dispensing with the need for an overhead mounted hood such as is taught by the prior art.

The oven itself is considered to be of a design according to the conventional art and typically includes a conveyor belt extending between an inlet side and an outlet side. One type of known oven in particular includes two conveyor belts in substantially horizontally extending and vertically spaced manner and the oven further including an open space defined within side walls associated with the inlet and outlet sides and which are contiguous with the upper side of each conveyor. The openings extend internally within the oven from the inlet to the outlet sides and typically account for the placement of the pizzas, or other food items, upon the conveyor.

Any number of individual hood assemblies are provided for use with the inlet and/or outlet sides of the oven and each typically includes a three-dimensional shaped body mountable to the associated oven side wall and so that a generally downwardly and elongate extending inlet is arrayed in an overhanging fashion above the conveyor belt. The elongated body further includes a filter, typically provided as one or more baffle designed filters, associated with the elongate extending inlet. An outlet is defined at a further location of the elongate body, typically along a top edge thereof, and is internally communicable with said inlet. In the preferred embodiment, pluralities of two or four such hood assemblies are provided for securing, respectively, to the inlet and outlet side walls of the conveyor oven and so that their respective inlets extend in overhead proximity to each of the heat zones created at the point where the conveyor extends beyond the associated side wall of the oven.

A length of ductwork connects to the elongated body at the outlet and extends in substantially upward fashion from the interior enclosure to an externally mounted blower assembly. In the preferred embodiment, individual manifolds secure to top edge locations of each of the elongated bodies. The upwardly extending ductwork in turn communicates with an end location of each manifold. When pluralities of hood assemblies are employed, typically first and second pairs on the inlet and outlet sides of the oven, the ductwork may further be divided into first and second branches, which converge into a single upwardly extending ductwork portion at a location above the room interior. A single exhaust fan or blower is typically mounted at an exterior (roof) location and vents to the outside the evacuated and filtered exhaust from the oven.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of the hood assembly for use with a conveyorized cooking oven according to a preferred embodiment of the present invention;

FIG. 2 is an exploded view in section of the interconnection between the hood, manifold and ductwork forming a part of the present invention;

FIG. 3 is an assembled view of the elements also illustrated in FIG. 2 and showing the manner in which the oven exhaust is evacuated from the hood to the exterior; and

FIG. 4 is a side cutaway view illustrating the cross sectional configuration of a selected hood body and attached manifold and further illustrating the manner in which the filter is mounted within the hood in proximity to the inlet.

### DETAILED DESCRIPTION OF THE PREFERRED EMBODIMENTS

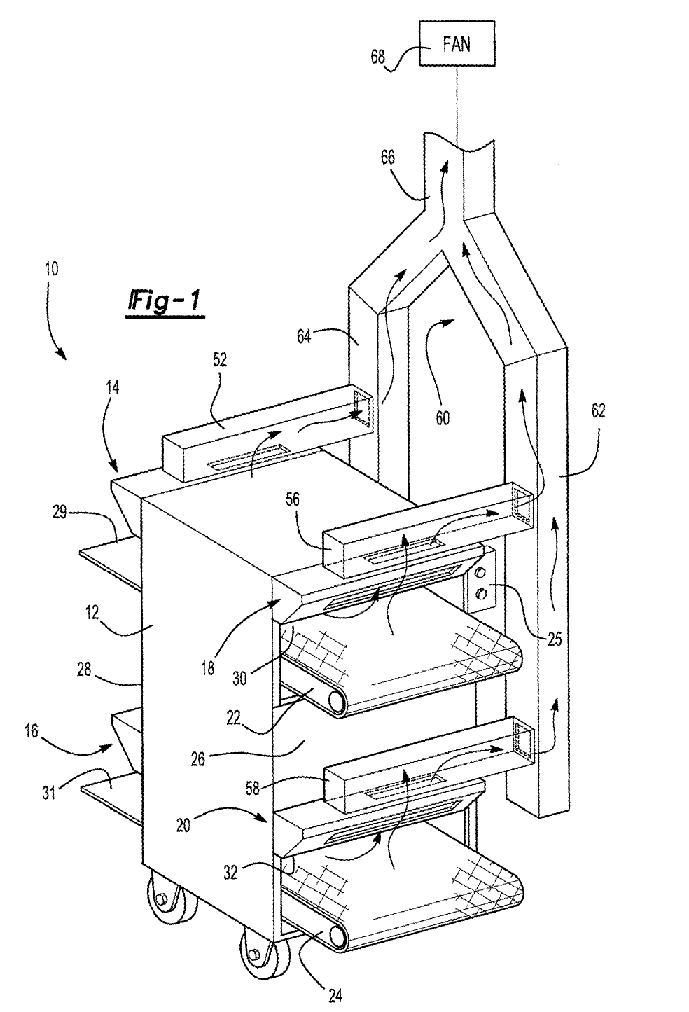

Referring now to FIG. 1, a general representation is rendered at 10 of a hood assembly for use with a conveyor type oven 12. According to the preferred embodiment of the present invention, the overall hood assembly is represented as a plurality of individual hoods 14, 16, 18 and 20, a further description of which will be provided below.

As previously explained, the present invention provides for much more efficient evacuation of heat, grease and other airborne particulates emanating from both inlet and, in particular, outlet sides of the conveyor oven. The design of the direct oven mounted hood unit of the present invention further provides the feature of more localized heat and particulate evacuation, thus doing away with the necessity of installing a make up air unit with the interior enclosure. Additionally, the construction of the hood and its associated ductwork results in much greater visibility from the front to back of the oven, and resulting from dispensing with the need for an overhead mounted hood such as is taught by the prior art.

The oven 12 itself is considered to be of a design according to the conventional art and typically includes at least one conveyor belt extending between an inlet side and an outlet side. One particular type of direct gas fired oven, commercially produced by Middleby Marshall, includes a first 22 and a second 24 conveyor belt in substantially horizontally extending and vertically spaced manner (commercial designation PS200 Double). The oven is activated from a control panel 25 with on/off controls and further includes an inlet side 26 from which the conveyor belts 22 and 24 extend to an outlet side 28 at which the belts terminate at ledges 29 and 31.

The oven 12 further includes an open space defined within and between the side walls 26 and 28 and which and which are contiguous with an upper side of each conveyor 22 and 24. The openings are best illustrated at 30 for first conveyor 22 and at 32 for second conveyor 24 and extend internally within the oven 12 from the inlet 26 to the outlet 28 sides. The openings 30 and 32 typically account for the open volume required within the oven for placement of pizzas, or other food items, upon the conveyor. As is also well known in the art, a significant heat zone is created at the inlet and, in particular, outlet openings of the conveyor oven and for which it is desirable to evacuate both the excess heat and associated particulates.

Accordingly, each hood assembly 14, 16, 18 and 20 illustrated in the embodiment 10 of FIG. 1 of the present invention is secured to an associated and external face location of the conveyor oven 12 corresponding to both its inlet 26 and outlet 28 sides. As is also further evident from the illustration of FIG. 1, the oven mounted hood assemblies 14, 16, 18 and 20 are each located in proximity to an associated heat exhaust zone created by the oven and at the location where conveyor belts 22 and 24 extend from the conveyor openings 30 and 32 and beyond the inlet 26 and outlet 28 sides of the oven. As is also well understood, any number of hood assemblies can be employed within the scope of the present invention, ranging from a single such assembly for application to a particularly “hot” exhaust zone to a plurality of four individual assemblies (as shown in FIG. 1) and which are present for the purpose of efficiently evacuating the heat zones created at the inlet and outlet of each conveyor belt.

Another preferred variant of the invention contemplates the provision of only a pair of two hood assemblies, such as 14 and 18 or 16 and 20 alone, and which correspond to a single conveyor (20 or 22). Such an oven is also commercially produced by Middleby Marshall and corresponds to the commercial designation PS200 Single.

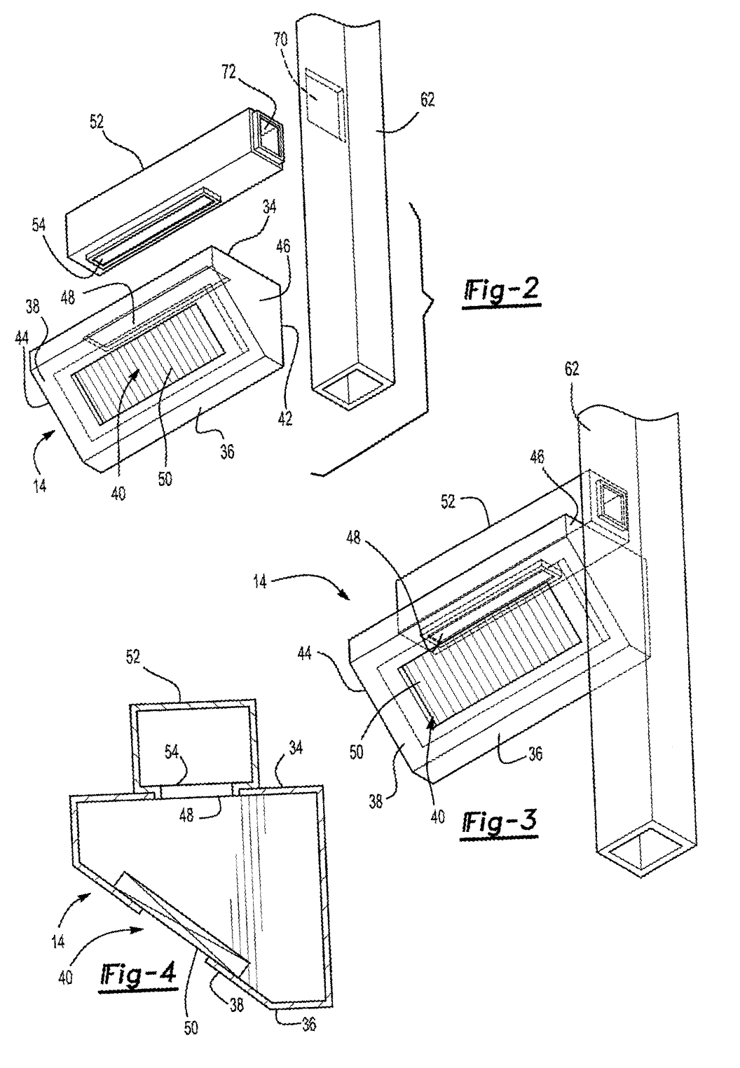

Referring to FIGS. 2-4, and in relation to FIG. 1, a better description is provided of the manner in which a selected hood assembly is mounted to both the oven 12 as well as to the exhaust ductwork configured according to the present invention. The illustrations of FIGS. 2, 3 and 4 apply to any of the individual hood assemblies 12, 14, 16 and 18 of FIG. 1. However, and for purposes of ease of illustration, hood assembly 14 will be represented in FIGS. 2-4 with the further understanding that the identical features exist for each other hood assembly.

Hood assembly 14 again includes an elongated and three-dimensional shaped body mountable to the oven side wall (see outlet side wall at 28 in FIG. 1) and typically constructed of a grade steel or like construction. The hood assembly 14 includes a top 34, a bottom 36, a first angled side 38 within which is defined an elongate extending inlet 40, a second generally perpendicularly extending side 42, a first end 44 and a second end 46. An outlet 48 is internally communicable with the inlet 40 (as best shown in FIG. 4) and is defined along the top edge 34 of the assembly 14. As is also clearly shown with reference to the drawings, the elongate extending inlet 40 is arrayed in a generally downwardly and overhanging fashion above the conveyor belt (or in this instance the ledge support 29 extending from the end of belt 22) and in particular can be arrayed at an angle relative to a plane defined by the conveyor belt.

The hood assembly body further includes a filtration insert 50 associated with the elongate extending inlet 40. The filtration insert in the preferred embodiment may consist of one or more baffle filter mounted in elongate extending fashion within the housing body and proximate to elongate extending inlet 40. The construction of the baffle filter is, by itself, known in the art and reference is again made to the disclosures of U.S. Pat. Nos. 6,041,772 and 6,041,774 which teach, in additional detail, such baffle mounted exhaust filters.

A substantially horizontally extending manifold 52 is provided and secures atop the associated top edge 34 of the hood assembly 14 and so that an opening 54 in a corresponding lower edge of the manifold aligns with the upper outlet end 48. The manifold 52 is constructed as a closed, elongate extending ductwork member and, referring again to FIG. 1, additional corresponding manifolds are provided for each of the other hood assemblies and in particular manifolds 56 and 58 are evident for hood assemblies 18 and 20, respectively. The corresponding manifold for hood assembly 16 is hidden in the view of FIG. 1 but is also understood to be present.

A length of ductwork (generally represented at 60 in FIG. 1) is provided for evacuating the localized exhaust components drawn from each of the hoods assemblies 14, 16, 18 and 20. The ductwork includes a first branch 62 and a second branch 64 connecting to each of the individual manifolds (see at 52, 56 and 58 as best shown in FIG. 1). The branches 62 and 64 converge into a single ductwork portion 66 extending in substantially upward fashion above the interior enclosure (not shown) within which the oven 12 is located and to an externally mounted blower assembly 68.

Referring again to FIGS. 2 and 3, the portion of specified branch 62 of the upwardly extending ductwork is represented and includes an aperture 70 which is seatingly engaged by a corresponding aperture 72 defined in an extending end of the manifold 52 and which internally communicable with the lower edge opening 54 in turn communicable with the outlet 48 of the hood 14. The particular construction of the ductwork 60 is intended to provide the combined features of flexibility in the arrangement of the oven 12 at any suitable location within the room interior (not otherwise tied to a pre-positioned and larger overhead mounted oven hood), combined with the ability to more efficiently remove heat and grease/particulates from the heat zones emanating from the oven conveyors and without the additional need for makeup air units. The oven mountable hood assembly of the present invention, in combination with the arrangement of the ductwork, further provides the advantage of permitting a much greater degree of visibility from the front to the rear of the oven (or other suitable piece of equipment), this again not possible in prior art arrangements where large and overhead fixed ventilation hoods are present.

Having described our invention, additional preferred embodiments will become apparent to those skilled in the art to which it pertains and without deviating from the scope of the appended claims.

We claim:

1. A hood assembly for use with an oven located within an interior enclosure, the oven including a conveyor belt extending between an inlet side and an outlet side, the oven further including an open space defined within side walls associated with the inlet and outlet side and contiguous with the upper side of the conveyor, the open space further extending from the inlet to the outlet sides of the oven, said hood assembly comprising:
at least one elongated and three-dimensional shaped body mountable to an oven side wall associated with at least one of the inlet and outlet sides, a generally downwardly and elongate extending inlet being arrayed in an overhanging fashion above the conveyor belt, said body further including filtration means associated with said elongate extending inlet, an outlet being defined at a further location of said elongate body and which is internally communicable with said inlet; and
a length of ductwork connecting to said elongated body at said outlet and extending in substantially upward fashion from the interior enclosure to an externally mounted blower assembly;
said hood assembly providing for more efficient removal of heat and airborne particulates originating from a heat zone established above the conveyor and at the inlet and outlet sides and with increased visibility across a top surface of the oven.

2. The hood assembly as described in claim 1, said filtration means further comprising at least one baffle filter mounted in elongate extending fashion within said body and proximate said elongate extending inlet.

3. The hood assembly as described in claim 2, said elongate extending inlet being arrayed at an angle relative to a plane defined by the conveyor belt.

4. The hood assembly as described in claim 3, said elongated body further comprising a top within which is defined said outlet, a bottom, a first angled side within which is defined said elongate extending inlet, a second side, a first end and a second end.

5. The hood assembly as described in claim 4, further comprising a substantially horizontally extending manifold secured to said top of said elongated body, said upwardly extending ductwork interconnecting with an end location of said manifold.

6. The hood assembly as described in claim 1, further comprising a plurality of elongated and three-dimensional shaped bodies secured to both the inlet and outlet side walls of the oven.

7. The hood assembly as described in claim 6, the oven further including an upper conveyor and a lower conveyor, said hood assembly further comprising first and second bodies mounting upon the inlet side and in proximity to the first and second conveyors, third and fourth bodies mounting upon the outlet side also in proximity to the conveyors.

8. The hood assembly as described in claim 7, further comprising first, second, third and fourth substantially horizontally extending manifolds secured, respectively, to top edges of each of said first, second, third and fourth elongated bodies and in which are defined each of said outlets.

9. The hood assembly as described in claim 8, said upwardly extending ductwork including a first branch communicating with end locations of said first and second manifolds, a second branch communicating with end locations of said third and fourth manifolds.

10. An oven mounted hood assembly, comprising:
an oven located within an interior enclosure, the oven including an upper conveyor belt extending between an inlet side and an outlet side and a likewise lower conveyor belt extending between the inlet and outlet sides, the oven further including open spaces defined within side walls associated with the inlet and outlet sides and which are contiguous with upper sides of each of the conveyor belts, the open spaces further extending from the inlet to the outlet sides of the oven;
a plurality of hood assemblies, each having an elongated and three-dimensional shaped body mountable to at least one of the oven side walls associated with the inlet and outlet sides, a generally downwardly and angularly facing and elongate extending inlet being arrayed in an overhanging fashion above the conveyor belt, said body further including a baffle filter mounted in elongate extending fashion within said body and proximate said elongate extending inlet associated with said elongate extending inlet, an outlet being defined at a further location of said elongate body and which is internally communicable with said associated inlet; and
a length of ductwork connecting to each of said elongated bodies at said outlets, said ductwork extending in substantially upward fashion from the interior enclosure to an externally mounted blower assembly;
said hood assembly providing for more efficient removal of heat and airborne particulates originating from a heat zone established above the conveyor and at the inlet and outlet sides and with increased visibility across a top surface of the oven.

11. An oven mounted hood assembly, comprising:
an oven located within an interior enclosure, the oven including upper and lower conveyor belts extending between inlet and outlet sides, open spaces being defined within side walls of the oven associated with the inlet and outlet sides and which are contiguous with upper sides of each of the conveyor belts, the open spaces further extending from the inlet to the outlet sides of the oven;
a plurality of first, second, third and fourth hood assemblies, each having an elongated and three-dimensional shaped body mountable to at least one of the oven side walls associated with the inlet and outlet sides, a generally downwardly and angularly facing and elongate extending inlet being arrayed in an overhanging fashion above the conveyor belt and including a filtration means for evacuating heat and airborne particulates from heat zones established above the conveyors, an outlet being defined at a further top edge location of each elongate body and which is internally communicable with said associated inlet; and
a plurality of first, second, third and fourth manifolds securing to associated top edge locations of each of said elongated bodies, a length of ductwork including first and second branches connecting to said manifolds associated with first and second pairs of said elongated bodies, said branches converging into a single ductwork portion extending in substantially upward fashion above the interior enclosure and to an externally mounted blower assembly.
